(19) United States
(12) Patent Application Publication
(10) Pub. No.: US 2025/0207999 A1
(43) Pub. Date: Jun. 26, 2025

(54) SYSTEM AND METHOD FOR DIAGNOSTICS OF A POWER ASSEMBLY

(71) Applicant: Transportation IP Holdings, LLC, Norwalk, CT (US)

(72) Inventors: Chirag Bipinchandraw Parikh, Erie, PA (US); Kent Jeffries, Erie, PA (US)

(73) Assignee: Transportation IP Holdings, LLC, Norwalk, CT (US)

(21) Appl. No.: 18/999,149

(22) Filed: Dec. 23, 2024

Related U.S. Application Data
(60) Provisional application No. 63/614,079, filed on Dec. 22, 2023.

(51) Int. Cl. G01M 15/05

(52) U.S. Cl. CPC G01M 15/05

(57) ABSTRACT

A method including receiving an operational pressure measurement of an engine, an operational temperature measurement of the engine, and an ambient pressure measurement. The method further includes calculating a pressure comparison value using the operational pressure measurement and the ambient pressure measurement. The method also includes identifying or predicting a deteriorated state of the engine using the pressure comparison value that is calculated and the operational temperature measurement that is received.

### CROSS-REFERENCE TO RELATED APPLICATION

This application claims benefit under 35 U.S.C. §119(e) to U.S. Provisional Application No. 63/614,079, filed Dec. 22, 2023, entitled “SYSTEM AND METHOD FOR DIAGNOSTICS OF A POWER ASSEMBLY,” the entire disclosure of which is hereby incorporated by reference herein.

### BACKGROUND

### Technical Field

Examples of the subject matter herein relate to a system and method of diagnostics for a power assembly.

### Discussion of Art

Vehicles and vehicle systems can include power assemblies to provide power to move the vehicle and/or vehicle system, for example engines, or the like. The various power assemblies may include hundreds, if not thousands, of different components. The components may degrade during operation in various ways. For example, an engine cylinder in an engine may start mis-firing due to a worn-out ignition plug. One approach to detect engine degradation is to monitor engine speed. Diagnostic routines can monitor whether components of the engine speed rise above a threshold level and generate diagnostic codes or other indications requesting service, de-rating engine power, or shutting down the engine. However, analysis of engine speed is often inadequate to thoroughly diagnose an engine problem.

Further, existing power assemblies may include protections built in to prevent further damage after a failure of the power assembly. However, existing power assemblies may be limited in diagnostic capabilities. Diagnostics may be able to prevent secondary damages of power assembly failure and may mitigate potential safety concerns. It may be desirable to provide a system and method for power assembly diagnostics that differs from existing power assembly diagnostics.

### BRIEF DESCRIPTION

In one embodiment, A method is provided that includes receiving an operational pressure measurement of an engine, an operational temperature measurement of the engine, and an ambient pressure measurement. The method may include calculating a pressure comparison value using the operational pressure measurement and the ambient pressure measurement. The method may include identifying or predicting a deteriorated state of the engine using the pressure comparison value that may be calculated and the operational temperature measurement that may be received.

In one embodiment, a system is provided that includes one or more processors that may receive an operational pressure measurement of an engine, an operational temperature measurement of the engine, and an ambient pressure measurement. The one or more processors may calculate a pressure comparison value using the operational pressure measurement and the ambient pressure measurement, and may identify or predict a deteriorated state of the engine using the pressure comparison value that may be calculated and the operational temperature measurement that may be received.

In one embodiment, a method is provided that includes obtaining sensor measurements of a manifold pressure of an engine, an exhaust temperature of the engine, and a power output of the engine. The method may include calculating a comparison value between the manifold pressure and a barometric air pressure. The method may include comparing each of the comparison value, the exhaust temperature, and the power output of the engine to a respective designated threshold. The method may include changing operation of the engine by reducing the power output by the engine responsive to the comparison value being less than the respective designated threshold, the exhaust temperature exceeding the respective designated threshold, and the power output exceeding the respective designated threshold.

### BRIEF DESCRIPTION OF THE DRAWINGS

The inventive subject matter may be understood from reading the following description of non-limiting examples, with reference to the attached drawings, wherein below:

FIG. 1 is a perspective view of a power assembly system, according to one example;

FIG. 2 is schematic overview of a vehicle system and control system, according to one example;

FIG. 3 is a schematic overview of a diagnostic system for a power assembly system, according to one example;

FIG. 4 is a flowchart of a method of diagnosing an operational condition of a power assembly system, according to one example; and

FIG. 5 is a flowchart of a method of diagnosing an operational condition of a power assembly system, according to one example.

### DETAILED DESCRIPTION

Examples of the subject matter described herein relate to systems and methods for diagnosing a power assembly. The power assembly may be included in a vehicle or vehicle system, for example a rail vehicle system. Other suitable types of vehicles may include on-highway vehicles, off-highway vehicles, mining equipment, aircraft, marine craft, or the like. Other embodiments may be used for stationary power assemblies such as wind turbines, power generators, or the like. The power assembly may include engines, such as diesel engines or engines that combust another fuel or combination of fuels. The vehicles may include power assemblies with components that may degrade with use.

With regard to the fuel, the fuel may be a single fuel type in one embodiment and in other embodiments the fuel may be a mixture of a plurality of different fuels. In one example of a fuel mixture, a first fuel may be liquid and a second fuel may be gaseous. A suitable liquid fuel may be diesel (regular, biodiesel, HDRD, and the like), gasoline, kerosene, dimethyl ether (DME), alcohol, and the like. A suitable gaseous fuel may be natural gas (methane) or a short chain hydrocarbon, hydrogen, ammonia, and the like. In one embodiment, fuel may be inclusive of stored energy as used herein. In that perspective, a battery state of charge, or a source of compressed gas, a flywheel, fuel cell, and other types of non-traditional fuel sources may be included.

The vehicles and vehicle systems described herein extend to multiple types of vehicles or vehicle systems. Suitable vehicle types may include automobiles, trucks (with or without trailers), rail vehicles or rail vehicle systems, buses, marine vessels, aircrafts, mining vehicles, agricultural vehicles, or other off-highway vehicles. The vehicle systems described herein (rail vehicle systems or other vehicle systems that do not travel on rails or tracks) can be formed from a single vehicle or multiple vehicles. With respect to multi-vehicle systems, the vehicles can be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together as a group. Vehicle systems may also be referred to as vehicle groups, convoys, consists, swarms, fleets, platoons, trains, etc.

The diagnostic systems and methods may use sensor data, for example, an operational pressure measurement of an engine, an operational temperature measurement of the engine, an ambient pressure measurement, or the like to diagnose conditions of the power assembly or auxiliary equipment.

The power assembly system may be put in a designated operating mode to look for particular types of power assembly system degradation. For example, the power assembly system may be diagnosed during a self-loaded mode, a dynamic brake setup mode, a steady state motoring mode, or the like. The diagnostic and prognostic methods described may be used for trending, comparing cylinder-to-cylinder variation, performing test procedures, repair confirmation, air in repair, or the like. In one example, the power assembly system data may be sampled and analyzed when the power assembly system reaches a particular operating mode or state during normal operation.

The diagnostic systems and methods may identify power assembly failures, for example a loose power assembly, turbo charger failure, valve train failure, air manifold failure, or the like. The diagnostic systems and methods may identify a failure based on a signature from the sensor data and may send a notification or take a responsive action based on the various sensed and calculated power assembly parameters.

A first level of notification may identify events and may collect continuous data around events responsive to a sensed or measured parameter exceeding a designated threshold at a designated operational level. A second level of notification may notify an operator and/or take responsive action to prevent further damage, based on the parameters defined under the first level and a change between sensed or measured parameters being lower than a designated threshold at a designated operational level. A third level of notification may notify an operator and may take a responsive action when the second level has occurred within a certain amount of time and loss of fuel pressure, loss of injector, or loss of water pressure may be identified. These levels may be adjusted and/or combined as needed based on a user's need and/or engineering needs.

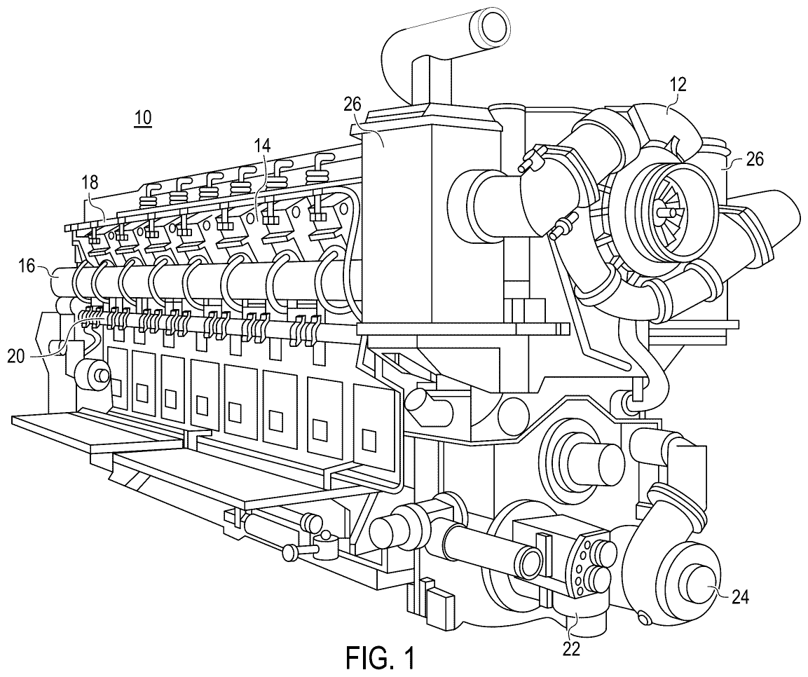

FIG. 1 illustrates an example of a power assembly system 10. The power assembly system may include an engine. The engine may include a turbo charger 12 and a series of unitized power or fuel injection assemblies 14. For example, a 12-cylinder engine may have 12 such power assemblies while a 16-cylinder engine may have 16 such power assemblies. The engine may further include an air intake manifold 16, a fuel supply line 18 for supplying fuel to each of the power assemblies, a water inlet manifold 20 used in cooling the engine, a lube oil pump 22, and a water pump 24. An intercooler 26 connected to the turbo charger may facilitate cooling of the turbo charged air before it enters a respective combustion chamber inside one of the power assemblies. The engine may be a V-style type or an in-line type.

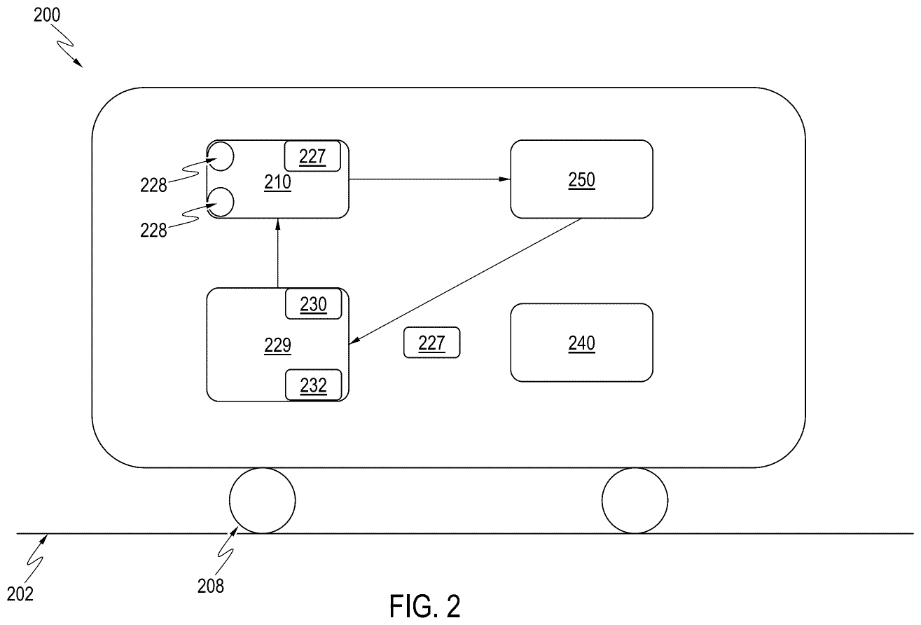

FIG. 2 illustrates a vehicle system and control system 200, according to one example. In one example, the vehicle system may be a rail vehicle that may run on a rail 202 via a plurality of wheels 208. The vehicle may have a propulsion system representing one or more engines 210. The engine may include one or more power assemblies 228. The power assemblies may be one or more cylinders.

The vehicle system may include one or more auxiliary systems 240. The auxiliary systems may be operatively connected to the engine. The auxiliary systems may be used to power components or systems of the vehicle system, other than the propulsion system. For example, the auxiliary system may power functions such as heating, cooling, providing electrical energy at outlets for use for passenger conveniences or necessities, or the like.

The vehicle system may include a controller 229 that may control various components of the vehicle system. In one example, the controller may include a computer control system. The computer control system may be largely software based and may include a processor, such as processor 230, that may execute computer operable instructions. The controller may include multiple engine control units (ECU) and the control system may be distributed among each of the ECUs. The controller may include computer readable storage media, such as a memory 232, including instructions (e.g., computer executable instructions) for enabling on-board monitoring and control of vehicle operation. The memory may include volatile and non-volatile memory storage. The controller may be hardware based using, for example, digital signal processors (DSPs) or other hardware logic circuitry to perform the various functions described herein.

If a system, apparatus, assembly, device, etc. (e.g., a controller, control device, control unit, etc.) includes multiple processors, these processors may be located in the same housing or enclosure (e.g., in the same device) or may be distributed among or between two or more housings or enclosures (e.g., in different devices). The multiple processors in the same or different devices may each perform the same functions described herein, or the multiple processors in the same or different devices may share performance of the functions described herein. For example, different processors may perform different sets or groups of the functions described herein.

The vehicle system may include one or more sensors 227. The sensors may measure characteristics of components of the vehicle, for example the engine, the power assembly, or the like. The sensors may be electrical sensors and/or mechanical sensors. The sensors may include a pressure sensor (e.g., barometer, manometer, Bourdon tube pressure sensor, vacuum pressure sensor, piezoelectric pressure sensor, strain gauge pressure sensor), an optical sensor (e.g., an infrared sensor, a proximity detector), an acoustic sensor (e.g., an ultrasonic sensor), a capacitive sensor, a photoelectric sensor, an inductive sensor, a laser distance sensor (e.g., Light Detection and Raging [“LIDAR”]), or the like. The mechanical sensors may measure the physical characteristics of the power assembly system or components thereof, for example, the engine, the power assemblies, ambient conditions, or the like.

The electrical sensors may include an ohmmeter measuring electrical resistance, a voltmeter measuring electrical potential in volts, an impedance analyzer measuring impedance, an ammeter measuring current, a database or memory, a thermometer measuring a temperature of the engine and/or power assembly, an input device (e.g., control panel, switch, keyboard, microphone, etc.), or the like. The electrical sensors may read the electrical characteristics of the vehicle, the power assembly, the engine, ambient conditions, or the like.

The vehicle system may include one or more communication devices 250. The communication device may allow communication between components of the vehicle system. In one example, the communication device may communicate with one or more other vehicle systems and/or other remote locations that are off-board the vehicle system. The communication device may include or represent an antenna (along with associated transceiver hardware circuitry and/or software applications) for wirelessly communicating with other vehicle systems and/or remote locations. Optionally, the communication device may communicate via one or more wired connections, such as a multiple unit (MU) cable, a trainline, an electrically controlled pneumatic (ECP) brake line, or the like.

The sensors may be communicatively coupled with the controller via the communication device. The controller may receive outputs of measured values from the sensors and may identify or diagnose an operational state of the power assembly system and/or the engine, as discussed further below. By using the outputs from the sensors, the controller may be able to detect failures or deterioration of components of the engine and may change operation and/or request repair of the components. This may help mitigate potential concerns and prevent secondary damage caused because of the deteriorated component.

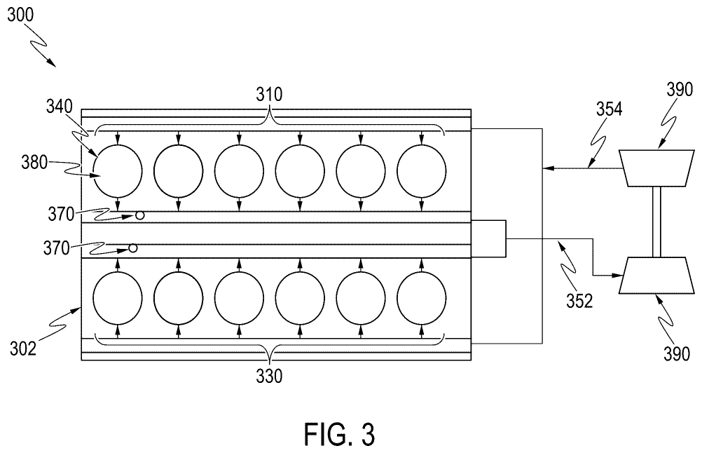

FIG. 3 illustrates a schematic overview of a diagnostic system for a power assembly system 300. The power assembly system may include an engine 302. The engine may include a series of power assemblies 340. Each power assembly may include a cylinder 380 and a corresponding fuel delivery assembly for delivering fuel to a combustion chamber within the cylinder. The cylinders may be arranged into a first cylinder bank 310 and a second cylinder bank 330. In another example, the cylinders may be arranged into one cylinder bank or more than two cylinder banks.

The diagnostic system may include one or more sensors 370. The sensors may include the electrical sensors or the mechanical sensors, discussed above. In one example, the sensors may measure an operational pressure of the engine, an operational temperature of the engine, and an ambient pressure.

The operational pressure of the engine may be a manifold air pressure of the engine. The operational pressure may be measured by one or more pressure sensors within the engine.

The operational temperature may be a temperature of exhaust from the engine. The temperature may be measured at a designated point in the engine (e.g., a central point or a point proximate the exhaust). However, in other examples, the temperature may be measured at more than one point, as discussed below.

The ambient pressure may be a barometric air pressure. A comparison value between the operational pressure and the ambient pressure may be calculated. The comparison value may be a difference between the two values or a ratio of the two values.

The diagnostic system may include a controller 390 that may communicate 354 with and control various components related to the diagnostic system and the power assembly system. The controller may include microcontrollers, processors, microprocessors, or other logic devices that operate based on instructions stored on a tangible and non-transitory computer readable storage medium, such as software applications stored on a memory. The controller may include computer readable storage media, such as a memory, including instructions (e.g., computer executable instructions) for enabling on-board monitoring and control of operation of the power assembly system.

The controller may include onboard electronic diagnostics for recording operational characteristics of the power assembly system. Operational characteristics may include measurements from the one or more sensors, for example. The operational characteristics may be stored in a database in the memory. In one example, current operational characteristics may be compared to past operational characteristics to determine trends of power assembly system performance.

The controller may include onboard electronic diagnostics for identifying and recording potential degradation and failures of components of the power assembly system. For example, responsive to a potentially degraded component being identified, a diagnostic code may be stored in the memory. In one example, a unique diagnostic code may correspond to each type of degradation that may be identified by the controller. For example, a first diagnostic code may indicate a problem with cylinder 1 of the engine, a second diagnostic code may indicate an air manifold failure, a third diagnostic code may indicate a loose power assembly, or the like.

The controller may be linked to a display, such as a diagnostic interface display, which may provide a user interface to an operating crew and a maintenance crew. The controller may control the engine, in response to operator input via user input controls, by sending a command to correspondingly adjust various engine components. User input controls may include a throttle control, a braking control, a keyboard, a power switch, or the like. Further, operational characteristics of the engine and auxiliary equipment, such as diagnostic codes corresponding to degraded components, may be reported via the display to the operator and/or the maintenance crew.

The sensors may communicate 352 measurements to the controller. The controller may use the measurements to calculate or determine comparison values. For example, a pressure comparison value may be determined using the operational pressure measurement and the ambient pressure measurement. In one example, the pressure comparison value may be a difference between the operational pressure and the ambient pressure. In another example, the pressure comparison value may be a ratio between the operational pressure and the ambient pressure.

The operational temperature may be a first operational temperature that may be measured in the first cylinder bank of the engine. A second operational temperature may be measured in the second cylinder bank of the engine. The controller may calculate a temperature comparison value using the first operational temperature and the second operational temperature. Calculating the temperature comparison may determine whether the first cylinder bank and the second cylinder bank may be operating differently.

Based on the outputs received from the sensors and/or the calculations performed, the controller may identify and/or diagnose the operational status of the power assembly system and components thereof. The controller may be able to determine whether the power assembly system may be in a fully operational state, a deteriorated state, a non-operational state, or the like. As used herein, a fully operational state may be a state where the power assembly system may be operating properly or capable of operating at full capacity or performance. A deteriorated state may be a state where the power assembly system may be operating below full capacity or where one or more components of the power assembly system may be damaged or not operating as expected. A non-operational state may be a state where the power assembly system may not be operational or functional.

The controller may compare the outputs to threshold ranges or values. If the outputs may be within the threshold ranges or values, the controller may determine that the power assembly system may be in a fully operational state. However, if one or more of the outputs may be outside of the threshold ranges or values, the controller may determine that the power assembly system may be in a deteriorated state. The deviations from the threshold ranges and values may indicate a problem with one or more components. In one example, the deteriorated state may be determined based on two or more of the outputs being outside the threshold ranges or values.

Deteriorated or degraded components may cause the power assembly system to operate less efficiently, with less power, and/or with more pollution, for example. Further, the condition of the deteriorated components may accelerate degradation of other components which may increase the likelihood of an overall power assembly system failure. A degraded engine cylinder is an example of a degraded power assembly system component. The diagnosis of the deteriorated or degraded state may include both a warning of degradation as well as an indication of the type and/or location of the degraded power assembly system component.

Based on the operational state of the engine (e.g., steady state motoring, dynamic braking, or the like), the controller may use different thresholds for the sensor outputs and calculations. The thresholds may be saved on a memory. The controller may identify or predict the deteriorated state of the engine using the measurements received from the sensors, as well as the calculation performed using the measurements.

The sensors may measure an operational power of the engine. The operational power of the engine may be determined based on a horsepower output of the engine, torque, or the like. The deteriorated state of the power assembly system may be identified or predicted using the pressure comparison value, the operational temperature, and the operational power of the engine. The operational power may function as a benchmark or reference value. For example, the operational temperature may be expected to be in a defined range for a defined operational power of the engine. Where the power of the engine may be greater, the operational temperature may be greater, as well. Incorporating the operational power of the engine into the identification of the deteriorated state may reduce the occurrence of false positives incorrectly identifying a deteriorated state by providing a benchmark or reference value.

Types of power assembly system deterioration or failures that can be diagnosed, distinguished, and isolated may include a worn-out ignition plug, a turbo failure, a loose power assembly, an air manifold failure, a fuel imbalance, broken mounting bolts, a faulty cylinder, a knocking in the engine, a low fuel input, a low compression, and a valve train failure, or the like. Once a deterioration or failure may be identified or diagnosed, a responsive action may be taken. Such responsive actions may include, for example, providing a warning or notification signal to the operator, adjusting an engine operating parameter (e.g., derating the engine power, shutting down at least one cylinder of the engine, shutting down the engine entirely, balancing cylinders of the engine), logging a maintenance action, and transmitting the diagnosed condition to a central location (e.g., via the communications system).

The identification of a deteriorated state by the controller may be determined based on one or more levels or steps associated with measured or calculated parameters. For example, a first level may be associated with the temperature of the engine, a second level may be associated with the pressure difference between the operational pressure and the ambient pressure, or the like. The levels may be sequential, meaning a first level must occur before a second level may occur or be evaluated, the second level must occur before a third level may occur or be evaluated, and so on. In another example, the levels may take place simultaneously.

In one example, the first level may be determined by the operational temperature exceeding a defined threshold at a predetermined power level. A first level incident may be reported or logged responsive to the first measurement of the operational temperature above the defined threshold. In another example, a first level incident may be reported or logged responsive to the measurement of the operational temperature being above the defined threshold for a predetermined about of time, for example, between 3-20 seconds.

The engine may have an operational temperature range that may be associated with the power level. For example, when the power level of the engine may be relatively low, the threshold temperature may be correspondingly relatively low. However, responsive to the power level of the engine being relatively high, the threshold temperature may be relatively high. This may allow the diagnostic system to adjust identification and diagnosis responsive to the status of the engine. The threshold temperature may also be adjusted based on a measured ambient temperature.

In another example, the first level may be determined by the temperature comparison value between the first cylinder bank and the second cylinder bank being above a defined threshold. Responsive to the temperature (or temperature comparison value) exceeding the defined threshold, the controller may provide a notification to an operator or a control system of the power assembly system. The controller may direct the sensors to continuously collect data responsive to the temperature exceeding the threshold. Continuously collecting data and monitoring the data may facilitate a better understanding of the deteriorated state. For example, the initial measurement outside of the defined threshold may be determined to be an error or aberration if the continuous monitoring reflects temperatures under the defined threshold. Conversely, the continuous monitoring may identify a particular component that may be causing the raise in temperature above the defined threshold.

In one example, a first level incident may be logged or reported responsive to the temperature comparison value between the first cylinder bank and the second cylinder bank being outside of the define threshold of −100 degrees Fahrenheit and 150 degrees Fahrenheit with the engine output being greater than 1150 hp. As previously discussed, the threshold range may be modified based on the operating mode, the engine output, the ambient conditions, or the like.

The second level of the deteriorated state may notify the operator or a control system, as well as take responsive action. The responsive action may reduce or prevent further damage as a result of the deteriorated state. The second level may be determined based on the parameters defined under the first level, as well as a difference between the operational pressure (e.g., the manifold air pressure) and the ambient pressure (e.g., the barometric air pressure) being lower than a defined threshold at the predetermined power level. A second level incident may be reported or logged responsive to the first measurement of the pressure difference below the defined threshold. In another example, a second level incident may be reported or logged responsive to the measurement of the pressure difference being below the defined threshold for a predetermined about of time, for example, between 3-20 seconds.

In one example, a second level incident may be logged or reported responsive to the difference between the operational pressure and the ambient pressure being less than 3 psi while the power output of the engine is less than or equal to 1400 hp. In another example, a second level incident may be logged or reported responsive to the difference between the operational pressure and the ambient pressure being less than 5 psi while the power output of the engine is greater than 1500hp. In other examples, the defined threshold may be modified based on the operating mode, the engine output, the ambient conditions, or the like. The delta between the operational pressure and the ambient pressure may indicate a charge air leak. In response to the pressure being lower than the defined threshold, fuel to the engine may be increased to maintain the power of the engine and increase the fuel-to-air ratio.

The third level of the deteriorated state may notify the operator or a control system, as well as take responsive action when the parameters of the first and second levels may have occurred within a certain amount of time and a loss of fuel pressure, a loss of injector, or a loss of water pressure may be identified.

The levels of the deteriorated state may be adjusted, combined, rearranged, or the like based on a user's needs and applicable engineering needs.

The controller may change the operation of the power assembly system responsive to the deteriorated state of the power assembly system being identified or predicted. The operation of the engine may be changed by deactivating a cylinder of the engine while the engine continues to operate. In one example, the cylinder that is deactivated may be the cylinder that may be identified or diagnosed as being in a deteriorated state. By reducing the number of cylinders, the power output may be reduced, which may reduce damage caused by operating in a deteriorated state. The operation of the engine may be changed by derating the engine, reducing the maximum power output limit of the engine, or deactivating the engine. These actions all may reduce the operating power and stress on the engine and may reduce or prevent secondary damage caused by the engine operating in a deteriorated state.

The deteriorated state of the power assembly system may be identified or predicted responsive to the pressure comparison value being less than a designated pressure threshold value. In one example, the deteriorated state may be identified or predicted responsive to the pressure comparison value being less than a designated pressure threshold value and the operational temperature exceeding a designated temperature threshold value. Incorporating the operational temperature into the identification of the deteriorated state may reduce the occurrence of false positives incorrectly identifying a deteriorated state by having multiple reference points. The deteriorated state of the power assembly system may be identified or predicted responsive to the pressure comparison value being less than a designated pressure threshold value and the temperature comparison value exceeding a designated temperature threshold value.

In one example, the deteriorated state of the power assembly system may be identified or predicted responsive to each of the pressure comparison value being less than a designated pressure value for longer than a threshold time and the operational temperature of the engine or a temperature comparison value exceeding a designated temperature value for longer than a threshold time. By evaluating the pressure comparison value and the temperature comparison value for a threshold time, a persistence or accuracy of the value may be greater. Said another way, the value may be more reliable because the time over which the value is determined may be greater. The threshold time may be between 2 seconds and 5 minutes.

A rate of change may be calculated by the controller for one or more of the operational pressure, the operational temperature, the pressure comparison value, or the like. Calculating the rate of change may allow the controller to more easily identify abrupt or significant changes over time. Additionally, calculating the rate of change may allow the controller to evaluate trends of the values over time. The controller may initiate changing the operation of the power assembly system at a time based on the rate of change that may be calculated.

Responsive to the identification or prediction of the power assembly system being in the deteriorated state, the controller may change the operation of the power assembly system. The controller may control the power assembly system by sending commands to various components such as engine, the power assemblies, the cylinders, or the like. For example, responsive to a deteriorated state being identified, the controller may send commands to deactivate a cylinder of the engine while the engine continues to operate, derate the engine, reduce a maximum power output of the engine, deactivate the engine, or the like. Signals from the controller may be bundled together into one or more wiring harnesses to reduce space in the system devoted to wiring and to protect the signal wires from abrasion and vibration.

Adjusting the operation of the power assembly system responsive to the deteriorated state being identified or determined may reduce or prevent damage caused by the deteriorated state. For example, thermal fatigue resulting in reduced component life, damaged seals, ejected power assemblies, and the like may be reduced or prevented by the responsive action implemented.

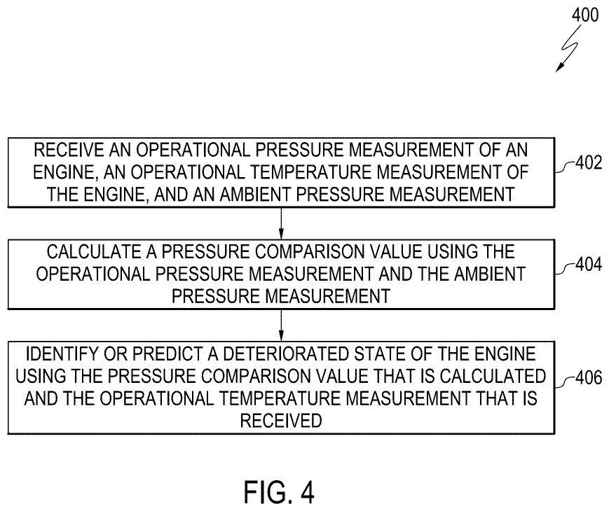

FIG. 4 illustrates a method 400 of diagnosing an operational condition of a power assembly system, according to one example. The power assembly system may include an engine. The power assembly system may be put in a designated operating mode to look for particular types of power assembly degradation. The diagnostic method may identify power assembly failures, for example a loose power assembly, turbo charger failure, valve train failure, air manifold failure, or the like. The diagnostic method may identify a failure based on a signature from sensor data and may send a notification or take a responsive action based on the various sensed and calculated power assembly parameters.

At step 402, the method may include receiving an operational pressure measurement of an engine, an operational temperature measurement of the engine, and an ambient pressure measurement. The operational pressure measurement may be manifold pressure of the engine. The operational temperature measurement may be an exhaust temperature. In one example, a first operational temperature may be measured in a first cylinder bank of the engine and a second operational temperature may be measured in a second cylinder bank of the engine. A controller may calculate a temperature comparison value using the first operational temperature measurement and the second operational temperature measurement. The ambient pressure measurement may be a barometric air pressure.

At step 404, the method may include calculating a pressure comparison value. The pressure comparison value may be calculated using the operational pressure measurement and the ambient pressure measurement. The pressure comparison value may be calculated as a difference between the operational pressure and the ambient pressure, however, in another example, the pressure comparison value may be a ratio of the operational pressure and the ambient pressure.

At step 406, the method may include identifying or predicting a deteriorated state of the engine using the pressure comparison value that is calculated and the operational temperature measurement that is received. The method may include determining whether the engine may be in a fully operational state, a deteriorated state, a non-operational state, or the like.

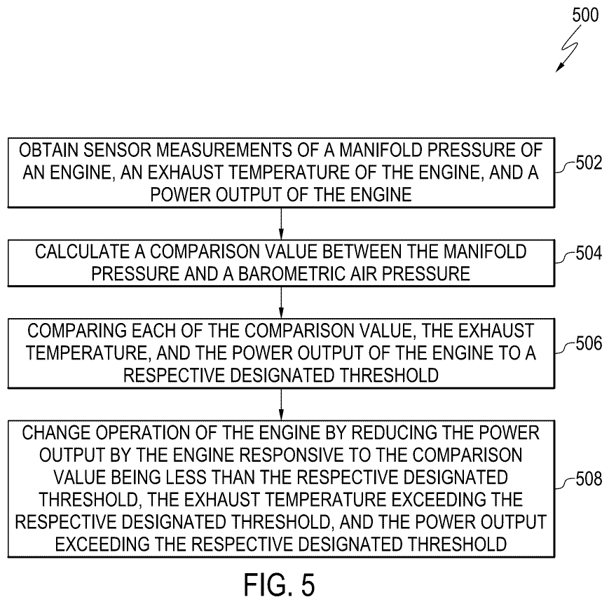

FIG. 5 illustrates a method 500 of diagnosing an operational condition of a power assembly system, according to one example. The power assembly system may include an engine. The diagnostic method may identify a deteriorated state based on a signature from sensor data and may send a notification or take a responsive action based on the various sensed and calculated power assembly parameters. The deteriorated state may be indicative of a turbo failure, a loose power assembly, broken mounting bolts, a valve train failure, an air manifold failure, or the like.

At step 502, the method may include obtaining sensor measurements of a manifold pressure of an engine, an exhaust temperature of the engine, and a power output of the engine. Sensors may include a thermometer, a pressure sensor (e.g., barometer, manometer, Bourdon tube pressure sensor, vacuum pressure sensor, piezoelectric pressure sensor, strain gauge pressure sensor), an optical sensor (e.g., an infrared sensor, a proximity detector), an acoustic sensor (e.g., an ultrasonic sensor), a capacitive sensor, a photoelectric sensor, an inductive sensor, a laser distance sensor (e.g., Light Detection and Raging [“LIDAR”]), or the like.

At step 504, the method may include calculating a pressure comparison value. The pressure comparison value may be calculated using the manifold pressure and the barometric air pressure. The pressure comparison value may be a difference between the manifold pressure and the barometric air pressure, a ratio of the manifold pressure and the barometric air pressure, or the like.

At step 506, the method may include comparing the comparison value to a first designated threshold, the exhaust temperature to a second designated threshold, and the power output of the engine to a third designated threshold. Comparing the values and measurements to the designated threshold may be indicative of whether the engine may be in a fully operational state, a degraded state, or the like.

At step 508, the method may include changing operation of the engine by reducing the power output by the engine responsive to the comparison value being less than the first designated threshold, the exhaust temperature exceeding the second designated threshold, and the power output exceeding the third designated threshold. Changing operation of the engine may include deactivating a cylinder of the engine while the engine continues to operate, derating the engine, reducing a maximum power output of the engine, or deactivating the engine.

In one embodiment, a method is provided that includes receiving an operational pressure measurement of an engine, an operational temperature measurement of the engine, and an ambient pressure measurement. The method may include calculating a pressure comparison value using the operational pressure measurement and the ambient pressure measurement. The method may include identifying or predicting a deteriorated state of the engine using the pressure comparison value that may be calculated and the operational temperature measurement that may be received.

In one example, the method may include changing operation of the engine responsive to the deteriorated state of the engine being identified or predicted. The operation of the engine may be changed by one or more of: deactivating a cylinder of the engine while the engine continues to operate, derating the engine, reducing a maximum power output limit of the engine, or deactivating the engine. The method may include calculating a rate of change in one or more of the operational pressure measurement, the operational temperature measurement, or the pressure comparison value. The initiation of changing the operation of the engine may begin at a time that may be based on the rate of change that may be calculated.

The deteriorated state of the engine may be identified or predicted responsive to the pressure comparison value being less than a designated pressure threshold value. The deteriorated state of the engine may be identified or predicted responsive to the pressure comparison value being less than the designated pressure threshold value and the operational temperature measurement exceeding a designated temperature threshold value.

The operational temperature measurement may be a first operational temperature measurement that may be measured in a first cylinder bank of the engine. The method may further include receiving a second operational temperature measurement of the engine. The second operational temperature measurement may be measured in a second cylinder bank of the engine. The method may include calculating a temperature comparison value using the first operational temperature measurement and the second operational temperature measurement. The deteriorated state of the engine may be identified or predicted responsive to the pressure comparison value being less than the designated pressure threshold value and the temperature comparison value exceeding a designated temperature threshold value.

The operational pressure measurement may be a manifold air pressure of the engine, the operational temperature measurement may be a temperature of exhaust from the engine, and the ambient pressure measurement may be barometric air pressure. The pressure comparison value that is calculated may include one or both of a difference between the operational pressure measurement and the ambient pressure measurement or a ratio between the operational pressure measurement and the ambient pressure measurement.

The method may include receiving an operational power measurement of the engine. The deteriorated state of the engine may be identified or predicted using the pressure comparison value that is calculated, the operational temperature measurement that is received, and the operational power measurement of the engine that is received.

The deteriorated state of the engine may be identified or predicted responsive to each of: (a) the pressure comparison value being less than a designated pressure value for longer than a threshold time and (b) the operational temperature measurement of the engine or a temperature comparison value that is based on the operational temperature measurement exceeding a designated temperature value for longer than a threshold time.

In one embodiment, a system is provided that includes one or more processors that may receive an operational pressure measurement of an engine, an operational temperature measurement of the engine, and an ambient pressure measurement. The one or more processors may calculate a pressure comparison value using the operational pressure measurement and the ambient pressure measurement, and may identify or predict a deteriorated state of the engine using the pressure comparison value that may be calculated and the operational temperature measurement that may be received.

In one example, the operational pressure measurement may be a manifold air pressure of the engine. The operational temperature measurement may be a temperature of exhaust from the engine. The ambient pressure measurement may be barometric air pressure. The one or more processors may calculate the pressure comparison value as one or both of a difference between the operational pressure measurement and the ambient pressure measurement or a ratio between the operational pressure measurement and the ambient pressure measurement.

The one or more processors may identify or predict the deteriorated state of the engine responsive to the pressure comparison value being less than a designated pressure threshold value. The one or more processors may identify or predict the deteriorated state of the engine responsive to the pressure comparison value being less than the designated pressure threshold value and the operational temperature measurement exceeding a designated temperature threshold value. The operational temperature measurement may be a first operational temperature measurement that may be measured in a first cylinder bank of the engine. The one or more processors may receive a second operational temperature measurement that may be measured in a second cylinder bank of the engine. The one or more processors may calculate a temperature comparison value using the first operational temperature measurement and the second operational temperature measurement. The one or more processors may identify or predict the deteriorated state of the engine responsive to the pressure comparison value being less than the designated pressure threshold value and the temperature comparison value exceeding a designated temperature threshold value.

The one or more processors may receive an operational power measurement of the engine. The one or more processors may identify or predict the deteriorated state of the engine using the pressure comparison value that is calculated, the operational temperature measurement that is received, and the operational power measurement of the engine that is received.

The one or more processors may identify or predict the deteriorated state of the engine responsive to each of: (a) the pressure comparison value being less than a designated pressure value for longer than a threshold time and (b) the operational temperature measurement of the engine or a temperature comparison value that is based on the operational temperature measurement exceeding a designated temperature value for longer than a threshold time.

In one embodiment, a method is provided that includes obtaining sensor measurements of a manifold pressure of an engine, an exhaust temperature of the engine, and a power output of the engine. The method may include calculating a comparison value between the manifold pressure and a barometric air pressure. The method may include comparing each of the comparison value, the exhaust temperature, and the power output of the engine to a respective designated threshold. The method may include changing operation of the engine by reducing the power output by the engine responsive to the comparison value being less than the respective designated threshold, the exhaust temperature exceeding the respective designated threshold, and the power output exceeding the respective designated threshold.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification, range limitations may be combined and/or interchanged, such ranges may be identified and include all the sub-ranges contained therein unless context or language indicates otherwise.

This written description uses examples to disclose the examples, including the best mode, and to enable a person of ordinary skill in the art to practice the examples, including making and using any devices or systems and performing any incorporated methods.

1. A method, comprising:
receiving an operational pressure measurement of an engine, an operational temperature measurement of the engine, and an ambient pressure measurement;
calculating a pressure comparison value using the operational pressure measurement and the ambient pressure measurement; and
identifying or predicting a deteriorated state of the engine using the pressure comparison value that is calculated and the operational temperature measurement that is received.

2. The method of claim 1, further comprising:
changing operation of the engine responsive to the deteriorated state of the engine being identified or predicted, the operation of the engine changed by one or more of:
deactivating a cylinder of the engine while the engine continues to operate, derating the engine, reducing a maximum power output limit of the engine, or deactivating the engine.

3. The method of claim 2, further comprising:
calculating a rate of change in one or more of the operational pressure measurement, the operational temperature measurement, or the pressure comparison value, wherein initiation of the changing the operation of the engine begins at a time that is based on the rate of change that is calculated.

4. The method of claim 1, wherein the deteriorated state of the engine is identified or predicted responsive to the pressure comparison value being less than a designated pressure threshold value.

5. The method of claim 4, wherein the deteriorated state of the engine is identified or predicted responsive to the pressure comparison value being less than the designated pressure threshold value and the operational temperature measurement exceeding a designated temperature threshold value.

6. The method of claim 4, wherein the operational temperature measurement is a first operational temperature measurement that is measured in a first cylinder bank of the engine, further comprising:
receiving a second operational temperature measurement of the engine, the second operational temperature measurement measured in a second cylinder bank of the engine; and
calculating a temperature comparison value using the first operational temperature measurement and the second operational temperature measurement,
the deteriorated state of the engine identified or predicted responsive to the pressure comparison value being less than the designated pressure threshold value and the temperature comparison value exceeding a designated temperature threshold value.

7. The method of claim 1, wherein the operational pressure measurement is a manifold air pressure of the engine, the operational temperature measurement is a temperature of exhaust from the engine, and the ambient pressure measurement is barometric air pressure.

8. The method of claim 1, wherein the pressure comparison value that is calculated includes one or both of a difference between the operational pressure measurement and the ambient pressure measurement or a ratio between the operational pressure measurement and the ambient pressure measurement.

9. The method of claim 1, further comprising:
receiving an operational power measurement of the engine, the deteriorated state of the engine identified or predicted using the pressure comparison value that is calculated, the operational temperature measurement that is received, and the operational power measurement of the engine that is received.

10. The method of claim 1, wherein the deteriorated state of the engine is identified or predicted responsive to each of:
(a) the pressure comparison value being less than a designated pressure value for longer than a first threshold time; and
(b) the operational temperature measurement of the engine or a temperature comparison value that is based on the operational temperature measurement exceeding a designated temperature value for longer than a second threshold time.

11. A system, comprising:
one or more processors configured to receive an operational pressure measurement of an engine, an operational temperature measurement of the engine, and an ambient pressure measurement, the one or more processors configured to calculate a pressure comparison value using the operational pressure measurement and the ambient pressure measurement, and identify or predict a deteriorated state of the engine using the pressure comparison value that is calculated and the operational temperature measurement that is received.

12. The system of claim 11, wherein the operational pressure measurement is a manifold air pressure of the engine, the operational temperature measurement is a temperature of exhaust from the engine, and the ambient pressure measurement is barometric air pressure.

13. The system of claim 11, wherein the one or more processors are configured to calculate the pressure comparison value as one or both of a difference between the operational pressure measurement and the ambient pressure measurement or a ratio between the operational pressure measurement and the ambient pressure measurement.

14. The system of claim 11, wherein the one or more processors are configured to identify or predict the deteriorated state of the engine responsive to the pressure comparison value being less than a designated pressure threshold value.

15. The system of claim 14, wherein the one or more processors are configured to identify or predict the deteriorated state of the engine responsive to the pressure comparison value being less than the designated pressure threshold value and the operational temperature measurement exceeding a designated temperature threshold value.

16. The system of claim 14, wherein the operational temperature measurement is a first operational temperature measurement that is measured in a first cylinder bank of the engine, and the one or more processors are configured to receive a second operational temperature measurement that is measured in a second cylinder bank of the engine, the one or more processors configured to calculate a temperature comparison value using the first operational temperature measurement and the second operational temperature measurement, the one or more processors configured to identify or predict the deteriorated state of the engine responsive to the pressure comparison value being less than the designated pressure threshold value and the temperature comparison value exceeding a designated temperature threshold value.

17. The system of claim 11, wherein the one or more processors are configured to receive an operational power measurement of the engine, the one or more processors configured to identify or predict the deteriorated state of the engine using the pressure comparison value that is calculated, the operational temperature measurement that is received, and the operational power measurement of the engine that is received.

18. The system of claim 11, wherein the one or more processors are configured to identify or predict the deteriorated state of the engine responsive to each of:
(a) the pressure comparison value being less than a designated pressure value for longer than a first threshold time; and
(b) the operational temperature measurement of the engine or a temperature comparison value that is based on the operational temperature measurement exceeding a designated temperature value for longer than a second threshold time.

19. The system of claim 11, wherein the one or more processors are configured to change operation of the engine responsive to the deteriorated state of the engine being identified or predicted, the operation of the engine changed by one or more of: deactivating a cylinder of the engine while the engine continues to operate, derating the engine, reducing a maximum power output limit of the engine, or deactivating the engine.

20. A method, comprising:
obtaining sensor measurements of a manifold pressure of an engine, an exhaust temperature of the engine, and a power output of the engine;
calculating a comparison value between the manifold pressure and a barometric air pressure;
comparing of the comparison value to a first designated threshold, the exhaust temperature to a second designated threshold, and the power output of the engine to a third designated threshold; and
changing operation of the engine by reducing the power output by the engine responsive to the comparison value being less than the first designated threshold, the exhaust temperature exceeding the second designated threshold, and the power output exceeding the third designated threshold.
